(19) United States
(12) Patent Application Publication
(10) Pub. No.: US 2008/0023679 A1
(43) Pub. Date: Jan. 31, 2008

(54) Novel flame retardant nanoclay

(76) Inventor: David Abecassis, Huntington, NY (US)

Correspondence Address: Thomas A. O'Rourke;Bodner & O'Rourke, 425 Broadhollow Road, Melville, NY, 11747, US

(21) Appl. No.: 11/801,993

(22) Filed: May 11, 2007

Related U.S. Application Data
(63) Continuation-in-part of application No. 11/645,093, filed on Dec. 22, 2006.
(60) Provisional application No. 60/799,489, filed on May 11, 2006.

(51) Int. Cl. C09K 21/12; C08K 3/34

(52) U.S. Cl. 252/609

(57) ABSTRACT

Flame retardant compositions of diphosphate coated clays are described. The compositions can be used as additives in polymeric compositions. The flame retardant composition can be used with other flame retardants in the polymeric composition.

The present application claims priority on provisional patent application Ser. No. 60/799,489 filed May 11, 2006 the disclosures of which are incorporated herein by reference. This is a continuation in part of U.S. application Ser. No. 11/645,093 filed Dec. 22, 2006, the disclosures of which are incorporated herein by reference.

### FIELD OF THE INVENTION

The present invention is directed to flame retardant nanoclay compositions that can be blended with a polymeric material while maintaining the processability of the polymeric material.

### BACKGROUND OF THE INVENTION

Common clays are naturally occurring minerals which have variability in their makeup. Natural clays can vary in their purity and composition. Clays are a product of the hydrolysis of magma originating alumino-silicate minerals. Clays have a particle structure that geologically often associates deposits with bodies of water during geological formation.

Of particular interest is the geometric arrangement of the silicate molecules into a planar sheet-like structure that is present in many clay species such as sodium bentonite derived smectites. The planar structure in the molecule is typically one molecular layer in thickness. The layer profile of these clay species is in the nanometer range while the surface formed by the sheet-like molecular structure is in the micron range.

The surface of these clays is ionic with a negative charge. As a result, in nature the clay structures are usually in multilayered stacked planes which are bonded together with polar or positively charged metallic ions. When these clays are suspended in water the crystals separate out and form suspended solids in the water column which can often associate with organic matter to form complex colloidal suspended solids. When these solids are suspended in the column and the column undergoes pH or ionic changes (as is the case in river deltas and brackish water), the clay or colloidal complex precipitates out of the column and forms clay layers.

Geologically, the smectites were produced by the direct deposition of fine volcanic ash which had been deposited in shallow seas resulting in a high purity monomolecular layered clay.

The same molecular structure that keeps Bentonite derived clay species in suspension has made them useful as thixotropic additives into aqueous solutions. This is particularly the case if the charges on the surface can be replaced by polymerization off of the clay surface or masked by organic treatment which makes them hydrophobic. In these instances they exhibit the same self dispersion in liquid polymers as they do in a column of de-ionized water. This has led to the development of polymer and quaternary amine treated smectites referred to in the plastics field as nano-clays.

Nano-clays when properly dispersed have strong property boosting effects in particular in creating high barrier and UV resistance while imparting greatly enhanced mechanical resistance. Another important use of these clays is as synergists and primary flame retardant additives. It has been discovered experimentally that well dispersed nanoclays in a thermoplastic act as synergists for difficult to achieve flame retardant requirements in combination with other flame retardants (i.e ASTM-E 84 Steiner tunnel test, UL-95 5V flame test) and can act as stand alone flame retardant additives for less stringent tests.

The current technology in the field which is based on quaternary amine treated clays has limitations due to the chemistry of the organic surface treatment. In particular the organic quaternary amine treated clays that are commercially available in the marketplace lose the ionicly bonded organic quaternary amines at around 200-220 degrees Celsius. When this occurs, the clay; which is now in a liquid melt polymer, loses it's affinity for the polymer and precipitates out or “reverts” negating it's nano-composite FR synergy properties and creating clay clumps within the plastic. This non exfoliated clay can still have some flame retardant effects as an inert ceramic filler would, but no longer exhibits gas barrier properties to the same degree.

This gas barrier property prevents flammable degradation gases from reaching the plastic surface and contributing to flammability. This effect is critical to the flame retardance of the thermoplastic since it is the fundamental mechanism for surface flame propagation. In addition the thixotropic effect of the dispersed nano-clay keeps the melt polymer in contact with flame from producing burning drips. Burning drips are a key evaluation criteria for many flame test ratings and is critical to flame spread minimization in real world fire scenarios. Nanoclays which revert, lose the benefits of rheology and the thermoplastic they are contained in as fillers are much more prone to quickly spreading fires to other objects during a fire. In addition, the quaternary amines and polymer residues found on traditional nano-clays are inherently flammable and contribute to combustion.

Accordingly, there is a need for improved nanoclays that do not suffer from the limitations of the quaternary amine based nanoclays. There is also a need for improved nanoclay based blends with polymeric materials that have flame retardant properties.

### OBJECTS OF THE INVENTION

It is an object of the invention to provide a thermo-stable nanoclay for use as a flame retardant.

It is also an object of the invention is to provide a more thermo-stable nano-clay for use with other flame retardant additives.

Another object of the invention is to provide a flame retardant organoclay which is a mixture of an organic based compound having a boiling point greater than 300° Celsius and a clay.

A further object of the invention is to provide an organoclay with inherent flame retardant properties.

A still further object of the invention is to provide an organoclay which has flame retardant properties.

A further object of the invention is to provide an organoclay which is blended with one or more polymeric materials to provide a polymeric composition with flame retardant properties.

Another object of the invention is to provide a diphosphate coated clay which is blended with one or more polymeric materials to provide a polymer composition with flame retardant properties.

Yet another object of the invention is to treat a clay with a one step low cost organic based material which organic material is without the inherent toxicity of prior art quaternary amines or the processing difficulty and cost of polymer-grafted nanoclays.

It is a further object to treat the nanoclay with an organic molecule that preferentially localizes itself at the clay surface past temperatures at which most polymer start to carbonize (i.e. 300 degrees Celsius).

Another object of the invention is to form an organoclay in a one step organic treatment of coating a clay with an organic material having a boiling point greater than 300° Celsius.

A still further object of the invention is to use an organic material which physically attracts and adheres either alone or with a clay to solid flame retardant particles to localize at the clay surface the flammable gases produced during burning.

It is an object of the invention to provide organoclay particles that localize at the clay surface the flammable gases produced during burning.

It is also an object of the invention to provide flame retardant particles where spatial efficiency of the flame retardant particles is maximized.

A further object of the invention is to treat the organoclay with a one step, low cost, non toxic nanoclay to decrease thermal conductivity of the polymer matrix.

Yet another object of the invention is to produce a stand alone flame retardant polymer additive from the use of the flame retardant clay.

Still another object is to produce higher temperature flame resistant nano-composites from thermoplastics.

### SUMMARY OF THE INVENTION

The present invention is directed to improved flame retardant compositions. The compositions are useful when blended with thermoplastic polymeric materials. The thermoplastic polymers can include one or more of the following polymers.
Polystyrene
Polyethylene
Polypropylene
Polyvinyl Chloride
Polymethylmethacrylate
Styrene Acrylonitrile
Polycarbonate
Acetyl Butyl Styrene
Polyurethane
Polyvinyl Acetate
Polyaniline
Cellulosic Thermoplastics
Nylon 6
Nylon
Non nylon polyamides
High Impact Polystyrene
Polyolefin Copolymers

The polymeric material is typically heated in an extruder or other blending device. To the polymeric material is added a flame retardant organoclay additive. The flame retardant additive is present in an amount ranging from 0.5% by weight additive to about 60% by weight additive.

The flame retardant additive is formed by blending a clay with an organic compound, preferably one having a boiling point greater than 300° Celsius. Preferred organic compounds are one or more diphosphates or blends thereof. Suitable diphosphates include resorcinol diphosphate and bisphenol diphosphate. The organic compound is preferably present in an amount of about 1% to about 50% diphosphate. More preferably, the amount of diphosphate is 1% to about 30% with the balance clay.

The flame retardant additive of the present invention can be added by itself to the polymeric material or it can be blended with another flame retardant material. Other flame retardant materials can include but are not limited to decabromodiphenyl ether, antimony oxide, brominated polystyrene, brominated polypropylene, low melting point glass, titanium dioxide, aluminum hydrates, calcium carbonate, talc, magnesium oxide, mineral phosphates, zinc chloride, phospenes, magnesium hydroxide, and Zinc Borate.

The diphosphate treated nanoclay is used as a synergist with the other flame retardant additives. The total amount of flame retardant additive in the polymeric blend can be 0.5% to about 60% by weight flame retardant with the balance polymer. The diphosphate treated clay can be about 0.5% by weight up to about 99.5% by weight of the flame retardant additive.

### DETAILED DESCRIPTION OF THE INVENTION

It has been found that improved flame retardant properties can be achieved using exfoliated clays that have been coated with an organic based material having a boiling point greater than 300° Celsius. In a preferred embodiment, nanoclays are treated with diphosphate compounds. The preferred diphosphate based compounds are resorcinol diphosphate based compounds and bisphenol diphosphate based compounds.

The diphosphate compounds are blended with a nanoclay which may be a smectite clay. The smectite clay can be a natural or synthetic clay mineral selected from the group consisting of hectorite, montmorillonite, bentonite, beidetite, saponite, stevensite and mixtures thereof. Montmorillonite is a preferred smectite clay.

The clay is blended with about 5% to about 60% by weight of the diphosphate compound. In a more preferred embodiment, the amount of diphosphate is present in an amount of about 5% to about 60% by weight.

The clay diphosphate blend is useful either alone as an additive that provides flame retardant properties or combined with other flame retardant additives. The clay diphosphate blend may be used as an additive with one or more polymeric materials including but not limited to polystyrene, polyolefine, polyethylene polypropylene, polyvinyl chloride, polymethylmethacrylate (PMMA), styrene acrylonitrite (SAN), polycarbonate, acetyl butyl styrene, polyurethane, polyvinyl acetate polyaniline, cellulosic thermoplastics, nylon, nylon 6, nylon 6, 6 and other nylons, non nylon polyamides, high impact polystyrene and blends thereof.

In the present invention an exfoliated clay is formed by blending a clay with resorcinol diphosphate (RDP) such that the resorcinol diphosphate coats at least a portion of the surface of the clay platelet, thereby providing improved exfoliation. Alternatively, the clay platelet may be blended with bisphenol diphosphate (BDP). The composition formed from the blending of the clay with either resorcinol diphosphate or bisphenol diphosphate or blends is used in the present invention. In a preferred composition, there is about 99% to about 50% clay with the balance RDP. Similarly, another preferred composition is 99% to about 50% BDP. The RDP or BDP or blends thereof physically coat the clay platelet and allows it to exfoliate. While it is possible to have compositions with more than 50% RDP or BDP, in such compositions the RDP and/or BDP acts as a plasticizer which may not always be a desired property for the particular application.

Other preferred compositions include blends of 95% to about 70% clay with the balance RDP and/or BDP.

In forming the blends of the present invention, it is preferred that the diphosphate material be heated to about 50° C. to about 100°. The liquid can be sprayed on to the clay and then the composition can be mechanically mixed to blend the materials together. Other means of mixing the clay and the diphosphate can be employed. It is also preferred that the diphosphate be heated to a temperature below its vapor point so that the diphosphate material is not lost.

In one embodiment of the invention, a polycationic polymer has been partially presaturated with ionically bonded flame retardant additives which are negatively charged. The negatively charged flame retardant additives can be used to exfoliate a clay.

I claim:

1. A flame retardant composition comprising of one or more polymeric materials and diphosphate coated clay particles.

2. The flame retardant composition according to claim 1 wherein the diphosphate is resorcinol diphosphate.

3. The flame retardant composition according to claim 1 wherein the diphosphate is bisphenol diphosphate.

4. The flame retardant composition according to claim 2 wherein said clay is blended with about 5% to about 60% by weight diphosphate.

5. The flame retardant composition according to claim 3 wherein said clay is blended with about 5% to about 60% by weight diphosphate.

6. The flame retardant composition according to claim 4 wherein said diphosphate coated clay particles comprise about 0.5% to about 60% by weight of the blend with said polymeric materials.

7. The flame retardant composition according to claim 5 wherein said diphosphate coated clay particles comprise about 0.5% to about 60% by weight of the blend with said polymeric materials.

8. The composition according to claim 1 wherein at least one of said polymeric materials is a polystyrene.

9. The composition according to claim 1 wherein at least one of said polymeric materials is a polyolefin.

10. The composition according to claim 1 wherein at least one of said polymeric materials is a polyvinyl chloride.

11. The composition according to claim 1 wherein at least one of said polymeric materials is a polymethylmethacrylate.

12. The composition according to claim 1 wherein at least one of said polymeric materials is a styrene acrylonitrite.

13. The composition according to claim 1 wherein at least one of said polymeric materials is a polycarbonate.

14. The composition according to claim 1 wherein at least one of said polymeric materials is a acetyl butyl styrene.

15. The composition according to claim 1 wherein at least one of said polymeric materials is a polyurethane.

16. The composition according to claim 1 wherein at least one of said polymeric materials is a polyaniline.

17. The composition according to claim 1 wherein at least one of said polymeric materials is a polyvinyl acetate.

18. The composition according to claim 1 wherein at least one of said polymeric materials is a celluosic thermoplastic.

19. The composition according to claim 1 wherein at least one of said polymeric materials is a nylon.

20. The composition according to claim 1 wherein at least one of said polymeric materials is a polyamide.

21. A flame retardant additive for polymeric materials comprising a diphosphate coated clay particle.

22. The additive of claim 21 further comprising one or more additional flame retardant additives.

23. The additive of claim 22 wherein said additional flame retardant additive is selected from the group consisting of decabromodiphenyl ether, antimony oxide, brominated polystyrene, brominated polypropylene, low melting point glass, titanium dioxide, aluminum hydrates, calcium carbonate, talc, magnesium oxide, mineral phosphates, zinc chloride, phospenes, magnesium hydroxide, and Zinc Borate.

24. The additive of claim 21 wherein said diphosphate is resorcinol diphosphate.

25. The additive of claim 21 wherein said diphosphate is bisphenol diphosphate.
